(19) United States
(12) Patent Application Publication
(10) Pub. No.: US 2026/0336324 A1
(43) Pub. Date: Oct. 29, 2026

(54) ERASER HOLDER FOR KNEADABLE ERASER

(71) Applicant: Adam Madar, Chicago, IL (US)

(72) Inventor: Adam Madar, Chicago, IL (US)

(21) Appl. No.: 19/409,116

(22) Filed: Dec. 4, 2025

Related U.S. Application Data
(60) Provisional application No. 63/793,587, filed on Apr. 23, 2025.

(51) Int. Cl. B43L 19/00

(52) U.S. Cl. CPC B43L 19/005

(57) ABSTRACT

An eraser holder for a kneadable eraser includes a case. The case includes a base and a sidewall, where the base and the sidewall together define an inner cavity. The sidewall defines a first airflow feature. The eraser holder further includes a retainer including a body portion, a first prong extending from the body portion, and a second prong extending from the body portion and spaced apart from the first prong. When the retainer is inserted into the inner cavity of the case in a first position, the body portion is configured to form a first seal with the case, and the first prong is configured to form a second seal with the case at the first airflow feature.

### CROSS-REFERENCE TO RELATED APPLICATIONS

This application claims the benefit of and priority to U.S. Provisional Patent Application No. 63/793,587, filed Apr. 23, 2025, the entire contents of which are hereby incorporated by reference herein.

### BACKGROUND

The present application relates generally to the field of drawing tools and, more specifically, art erasers for the purposes of drawing and sketching.

### SUMMARY

One embodiment relates to an eraser holder for a kneadable eraser includes a case. The case includes a base and a sidewall, where the base and the sidewall together define an inner cavity. The sidewall defines a first airflow feature. The eraser holder further includes a retainer including a body portion, a first prong extending from the body portion, and a second prong extending from the body portion and spaced apart from the first prong. When the retainer is inserted into the inner cavity of the case in a first position, the body portion is configured to form a first seal with the case, and the first prong is configured to form a second seal with the case at the first airflow feature.

In some embodiments, the retainer is configured to rotate within the case. In some embodiments, the first prong of the retainer is configured to break the second seal between the first airflow feature of the case and the first prong of the retainer when the retainer is rotated within the case into a second position. In some embodiments, the case includes a first edge circumscribed around an opening to the inner cavity, where the first edge is conically shaped.

In some embodiments, the first airflow feature is a first airhole defined through the sidewall of the case. In some embodiments, the first airflow feature is a first channel defined at least partially in an inner surface of the sidewall of the case, where the first channel extends from proximate a first edge circumscribed around an opening to the inner cavity of the case to the base thereof.

In some embodiments, the case further includes a second airflow feature positioned opposite to the first airflow feature. In some embodiments, the second prong of the retainer is configured to form a third seal with the second airflow feature of the case when the retainer is inserted into the case in the first position.

In some embodiments, the body portion of the retainer forms the first seal with the first edge of the case when the retainer is inserted into the case. In some embodiments, the retainer further includes a handle extending from the body portion for a user to insert a finger through the handle to move the retainer.

Another embodiment relates to an eraser holder for a kneadable eraser, with the eraser holder including a case defining a cavity, where the case includes a sidewall defining an opening and an airflow feature. The eraser holder further includes a retainer configured to be at least partially inserted into the cavity through the opening, where the retainer is further configured to retain a kneadable eraser. The retainer is further configured to form a first seal with the case at the airflow feature.

In some embodiments, the retainer includes a first prong, and a second prong spaced apart from the first prong, where the first prong and the second prong retain the kneadable eraser. In some embodiments, the case defines a first airflow feature configured to provide airflow into the cavity of the case. In some embodiments, the case further defines a second airflow feature configured to provide airflow into the cavity of the case, where the second airflow feature is positioned opposite the first airflow feature.

In some embodiments, the retainer is configured to rotate within the case when the retainer is inserted into the case, where the first prong of the retainer is configured to form a second seal with the first airflow feature of the case, and where rotating the retainer within the case is configured to either form the second seal by positioning the first prong to cover the first airflow feature when the retainer is in a first position and break the second seal with the first prong positioned away from the first airflow feature when the retainer is in a second position. In some embodiments, the second prong of the retainer is configured to form a third seal with the second airflow feature of the case when the retainer is inserted into the case, and where rotating the retainer within the case is configured to form the third seal by positioning the second prong to cover the second airflow feature when the retainer is in the first position and break the third seal by positioning the second prong away from the second airflow feature when the retainer is in the second position.

In some embodiments, the retainer is configured to rotate within the case when the retainer is inserted into the case, the retainer rotatable using a handle extending from a body portion of the retainer, where the body portion is positioned outside the cavity of the case when the retainer is inserted into the case.

Another embodiment relates to a method for forming an eraser holder for a kneadable eraser. The method includes forming a case defining an opening and a retainer; forming a first airflow feature at least partially in a sidewall of the case; forming a first prong and a second prong on the retainer; and inserting the retainer into the opening of the case, thereby forming a first seal between the retainer and the case, and the first prong of the retainer forms a second seal with the first airflow feature of the case.

In some embodiments, method further includes positioning a kneadable eraser between the first prong and the second prong. In some embodiments, the retainer is configured to rotate within the case, and where the first prong of the retainer is configured to break the second seal between the first airflow feature of the case with the first prong of the retainer when the retainer is rotated within the case.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is an exploded view of an eraser holder for a kneadable eraser, according to an exemplary embodiment;

FIG. 2 is a front perspective view of the eraser holder of FIG. 1, according to an embodiment;

FIG. 3A is a side view of a case of the eraser holder of FIG. 1, according to an embodiment;

FIG. 3B is a front view of a retainer of the eraser holder of FIG. 1, according to an embodiment;

FIG. 3C is a side view of a retainer of the eraser of FIG. 1, according to an embodiment;

FIG. 4 is a top perspective view of a case of the eraser holder of FIG. 1, according to an embodiment;

FIG. 5A is a side perspective view of a retainer of the eraser holder of FIG. 1, according to an embodiment;

FIG. 5B is a front perspective view of a retainer of the eraser holder of FIG. 1, according to an embodiment;

FIG. 6 is a flow diagram of a method for assembling the eraser holder for the kneadable eraser, according to an embodiment;

FIG. 7 is a flow diagram of another method for assembling the eraser holder for the kneadable eraser, according to an embodiment;

FIG. 8 is a flow diagram of a method for manufacturing an eraser holder for a kneadable eraser, according to an embodiment;

FIG. 9 is a perspective view of an eraser holder for a kneadable eraser, according to another embodiment;

FIG. 10 is a top view of a case of the eraser holder of FIG. 9;

FIG. 11 is a perspective view of an upper end of the case of the eraser holder of FIG. 9, showing an air passageway defined by the case, according to an embodiment; and

FIG. 12 is a top view of the eraser holder of FIG. 9, showing a profile of the air passageway that is defined by the case.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the figures generally, embodiments disclosed herein relate to an eraser holder for a kneadable eraser. The eraser holder includes a case defining a cavity, and a retainer configured to be at least partially inserted into the cavity of the case. The retainer is configured to retain a kneadable eraser. The eraser holder is configured to enclose and protect the kneadable eraser from debris and other contaminants in between uses. In some embodiments, the retainer and the case are rotatable relative to one another to selectively enclose the kneadable eraser with respect to the surrounding environment. The retainer may also include features (e.g., air channels, air passageways, air openings) that facilitate removal of the kneadable eraser from the eraser holder when rotated relative to the case, where air openings enable airflow to unstick and/or access a kneadable eraser positioned within the eraser holder.

In some embodiments, the retainer is configured to form a first seal (e.g., a covering, a blockage, a substantially airtight seal) between the retainer and the case to enclose the kneadable eraser within the eraser holder when the retainer is fully installed into the case. In some embodiments, the retainer includes a first prong and a second prong positioned opposite the first prong (e.g., prongs). The first prong and the second prong together are configured to retain (e.g., hold, support, etc.) the kneadable eraser separately from the case. The retainer may be configured such that the kneadable eraser is kept in place via a friction fit with the first prong and the second prong.

Kneadable erasers have sticky, puddy-like textures, which may help support the kneadable erasure in engagement between the first prong and the second prong to keep the kneadable eraser in place within the retainer. Further, the kneadable eraser may be retained in a friction fit arrangement with the case when the kneadable eraser is positioned within the case by inserting the retainer into the case. In some embodiments, the case is configured to compress the first prong toward the second prong when the retainer is inserted into the case, which can help maintain engagement between the retainer and the kneadable eraser during removal of the retainer from the case.

The case may define multiple openings that extend into an inner cavity defined by the case. For example, the case may define a first air opening (e.g., a first sidewall opening) extending into the cavity through a sidewall of the case, and a second air opening (e.g., a second sidewall opening) extending into the cavity through an opposing sidewall, or opposing portion of the sidewall, of the case. In some embodiments, the second air opening is positioned opposite the first air opening. The retainer is configured to rotate within the case when the retainer is inserted into the case. The first prong of the retainer is configured to form a second seal with the first air opening of the case when the first prong is rotationally aligned with the first air opening. The eraser holder is configured such that rotating the retainer within the case selectively forms the second seal by positioning the first prong to cover the first air opening, or breaks (e.g., uncovers) the second seal by moving the first prong away from the first air opening.

The second prong of the retainer is configured to form a third seal with the second air opening of the case when the retainer is inserted into the case and rotationally aligned with the case. The eraser holder is configured such that rotating the retainer within the case selectively forms the third seal by positioning the first prong to cover the first air opening, or breaks (e.g., uncovers) the third seal by moving the first prong away from the first air opening.

In some embodiments, the eraser holder is further configured to prevent the kneadable eraser from sticking to the case during removal operations. For example, the eraser holder may be configured such that rotating the retainer within the case breaks or otherwise separates the kneadable eraser from inner surfaces of the case. The eraser holder may be further configured so that relative rotation between the retainer and the case uncovers one or more of the first and second air openings, enabling airflow into the eraser holder and/or providing access to the cavity, which can facilitate removal of the retainer from the case and access to the kneadable eraser.

Kneadable erasers are pliable erasing tools typically made of unvulcanized rubber with a texture similar to putty or chewing gum. Kneadable erasers are excellent at picking up—via absorption—graphite, charcoal, carbon, colored pencil, or pastel marks. Kneadable erasers have a high plasticity and can be molded for precise erasing and/or contouring, hence why they are desirable by artists and those in artistic based professions (e.g., map drawing, surveying). Kneadable erasers last a long time because they can be rinsed to remove the excess erased material and then be kneaded to enable further erasing. However, because of the material and texture of kneadable erasers, the eraser may also inadvertently pick up dirt, dust, and other unwanted debris and contaminants. Once the eraser is saturated with debris/contaminants (e.g., dirty) it may become brittle and crusty. Further, the kneadable eraser may lose functionality, as it struggles to absorb more graphite and/or charcoal. The dirty kneadable eraser may also begin to leave marks on paper instead of removing marks. Rinsing does not work as well to clear dirt and dust from the eraser, which cling to the eraser, due to its texture. The difficulty associated with the removal of dirt, dust, or other unwanted debris from the kneadable eraser can defeat a major purpose of a kneadable eraser: longevity.

The eraser holder of the present disclosure substantially prevents and/or limits debris from contaminating the eraser so that the kneadable eraser stored within is kept clean. Keeping the kneadable eraser clean reduces the need to wash or otherwise decontaminate the eraser and extends the lifespan of the eraser. The eraser holder of the present disclosure can also help to prevent the kneadable eraser from being lost.

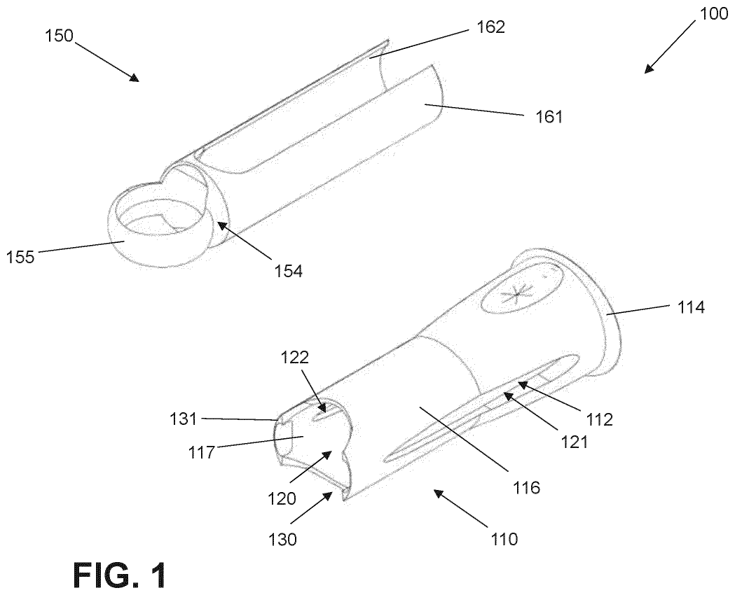

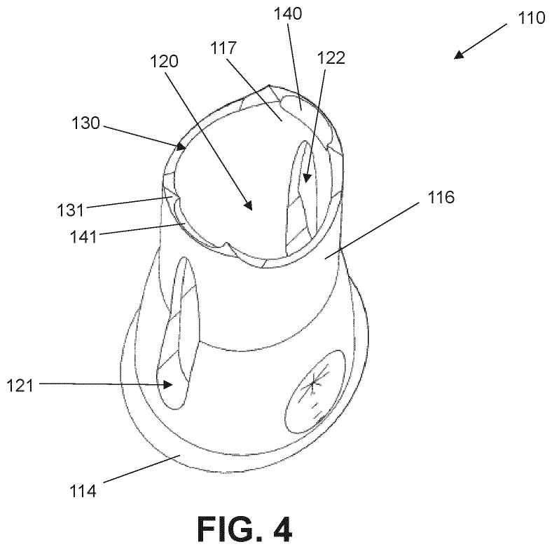

Referring to FIGS. 1-5B and 9-12, an eraser holder 100 for a kneadable eraser 190 is shown, according to an exemplary embodiment. The eraser holder 100 includes a case 110 and a retainer 150. The case 110 includes a base 114 (e.g., a bottom end of the case 110) and a sidewall 116 extending from the base 114. The base 114 and the sidewall 116 together define an inner cavity 120. The inner cavity 120 is sized to receive at least a portion of the retainer 150 therein. The case 110 includes an open end and a closed end (e.g., where the base 114 is the closed end). For example, the case 110 defines an opening 130 and a first edge 131 that circumscribes the opening 130. The sidewall 116 of the case 110 defines the opening 130 (e.g., an opening to the cavity 120) located opposite from the base 114 (e.g., a top end of the case 110).

The case 110 includes one or more airflow features 112 (e.g., openings, recesses, channels, etc.) defined therein (e.g., the sidewall 116, etc.). The one or more airflow features 112 are configured to selectively provide airflow into the cavity 120 of the case 110 when the retainer 150 is inserted therein. For example, when the retainer 150 is positioned to cover the one or more airflow features 112, airflow into the case 110 (e.g., the cavity 120 thereof) is substantially prevented, where positioning the retainer 150 within the case 110 to uncover the one or more airflow features 112 allows for airflow into the case 110.

Referring to FIGS. 1-5B, one of the one or more airflow features 112 of the case 110 may be configured as a first airhole 121. For example, the first airhole 121 may extend between the open end and the closed end of the case 110. The first airhole 121 may be defined in the sidewall 116 of the case 110.

In some embodiments, a second of the one or more airflow features 112 of the case 110 may be configured as a second airhole 122. The second airhole 122 may extend between the open end and the closed end of the case 110. The second airhole 122 may be defined in the sidewall 116 of the case 110. The second airhole 122 may be positioned opposite to the first airhole 121. For example, the first airhole 121 and the second airhole 122 may be positioned in parallel, so the case 110 is symmetrical. In some embodiments, the second airhole 122 may not be positioned opposite the first airhole 121. In some embodiments, the case 110 may define more or less than two airholes (e.g., a third sidewall opening) in the sidewall 116.

The eraser holder 100 further includes the retainer 150. The retainer 150 is configured to be inserted into the case 110 through the opening 130. The retainer 150 is configured to support (e.g., retain) the kneadable eraser 190. The retainer 150 supports the kneadable eraser 190 when the retainer 150 is inserted into the case 110 and facilitates removal of the kneadable eraser 190 from the case 110. In some embodiments, and as shown, the retainer 150 includes a body portion 154 (e.g., a base of the retainer 150). The body portion 154 is configured to be positioned outside the cavity 120 when the retainer 150 is inserted into the case 110. A first seal may be formed between the retainer 150 and the case 110 when the retainer 150 is inserted into the case 110. The first seal may be formed between the body portion 154 of the retainer 150 and a first edge 131 circumscribing the opening 130 of the case 110. In some embodiments, the first seal is airtight. In some embodiments, the first seal is defined as a covering of the opening 130 of the case 110.

As used herein, the term “seal” should be understood to encompass both airtight and non-airtight arrangements. For example, the seal may be a covering for an opening (e.g., the opening 130 and/or an airhole) in the eraser holder (e.g., the case) that does not form an airtight seal with the case. For example, the seal may encompass a blockage or barrier that helps to prevent the ingression of dirt and/or other contaminants through an opening in the case. In other embodiments, the seal may refer to an airtight and/or liquid tight seal.

In some embodiments, the retainer 150 includes a seal member (e.g., an O-ring, a gasket, etc.). In some embodiments, the eraser holder 100 is configured so that the seal member engages an inner surface 117 of the case 110 when the retainer 150 is installed into the case 110. The seal member is configured to sealingly engage the inner surface 117 of the case 110, in a region of the inner surface 117 proximate to the first edge 131, when the retainer 150 is inserted into the case 110. In some embodiments, the case 110 includes a seal member (e.g., a second seal member spaced axially apart from the first seal member, etc.) for sealingly engaging the retainer 150 (e.g., the body portion portion), when the retainer 150 is installed into the case 110.

Referring to FIGS. 1, 3B, and 5A-5B, the retainer 150 includes a first prong 161, and a second prong 162. In some embodiments, the retainer 150 may include additional or fewer prongs. The first prong 161 and/or the second prong 162 are configured to engage an inner surface 117 of the case 110 when the retainer 150 is inserted into the case 110. In some embodiments, the first prong 161 and/or the second prong 162 are shaped complimentary to the inner surface 117, which can help to reduce ingestion of contaminants into the cavity 120 when the retainer 150 is inserted into the case 110. For example, the retainer 150 may be structured such that a first profile of an outer surface of the first prong 161 and/or the second prong 162 matches a second profile of an inner surface of the case 110.

With reference to FIGS. 1, 3A, and 4, the depicted embodiments show the case 110 of the eraser holder 100. The case 110 includes the first edge 131 and the first airhole 121. In some embodiments, the case 110 is generally cylindrical. The case 110 includes an inner surface 117 and an outer surface (e.g., of the sidewall 116). In some embodiments, the first airhole 121 extends through the outer surface and the inner surface 117 of the case 110. For example, the first airhole 121 may be a slit through the case 110.

With reference to FIGS. 1, 3B, and 5A-5B, the depicted embodiment shows the retainer 150 of the eraser holder 100. The first prong 161 extends from the body portion 154 of the retainer 150. The second prong 162 may extend from the body portion 154 of the retainer 150. The second prong 162 is spaced apart from the first prong 161 (e.g., may be positioned opposite to the first prong 161). For example, the first prong 161 and the second prong 162 may be positioned so the retainer 150 is symmetrical. In some embodiments, the second prong 162 is not positioned opposite to the first prong 161. The retainer 150 may include more or less than two prongs (e.g., a third prong). The retainer 150 including multiple prongs may be configured with the multiple prongs evenly spaced apart. In some embodiments, the first prong 161 and the second prong 162 are configured similarly to each other (e.g., the same length, same width, etc.). In some embodiments, the first prong 161 and the second prong 162 may be configured differently from each other (e.g., different lengths, different widths, etc.).

The body portion 154 of the retainer 150 includes a handle 155. The handle 155 extends from the body portion 154, where the handle 155 is configured for a user to insert a finger through the handle 155 to hold and/or move the retainer 150 (e.g., shaped like a ring). The handle 155 extends in the opposite direction to the first prong 161 and/or the second prong 162 of the retainer 150. The handle 155 may extend from the body portion 154. The retainer 150 including the handle 155 may be symmetrical. In some embodiments, the body portion 154 is also configured so the retainer 150 may be rotated within the case 110 (e.g., by the user turning their finger).

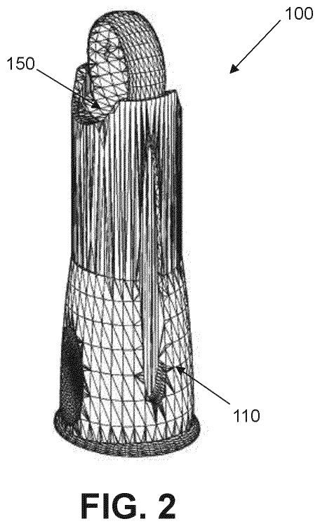

With reference to FIG. 2, the depicted embodiment shows the eraser holder 100 configured with the retainer 150 inserted into the case 110. With reference to FIGS. 1 and 3A through 5B, the depicted embodiments show components (e.g., retainer 150, case 110) of the eraser holder 100. In some embodiments, the retainer 150 is inserted into the opening 130 of the case 110. In some embodiments, when the retainer 150 is inserted into the case 110, the first seal is formed between the retainer 150 and the case 110. In some embodiments, the first seal is substantially airtight. In some embodiments, the first seal may be a covering (e.g., a non-airtight covering) where the retainer 150 (e.g., the body portion 154 thereof) covers the case 110 (e.g., the opening 130) to thereby prevent ingression of dirt and other contaminants into the eraser holder 100.

In some embodiments, the first prong 161 of the retainer 150 forms a second seal (e.g., covering, blockage, etc.) with the first airhole 121 of the case 110 when the retainer 150 is inserted into the case 110. In some embodiments, the second seal is substantially airtight. In other embodiments, the second seal may be a non-airtight covering. In some embodiments, the second seal may be defined where the first prong 161 covers and/or blocks the first airhole 121. In some embodiments, the second prong 162 of the retainer 150 forms a third seal with the second airhole 122 of the case 110 when the retainer 150 is inserted into the case 110. In some embodiments, the third seal is substantially airtight. In other embodiments, the third seal may be defined where the second prong 162 covers and/or blocks the second airhole 122 but does not form an airtight or liquid tight seal. Covering and/or blocking the first airhole 121 and/or the second airhole 122 substantially prevents debris and other contaminants from entering the case 110 (e.g., entering the cavity 120), thereby protecting the kneadable eraser 190 (if inside the cavity 120).

In some embodiments, the first prong 161 may form the second seal with the second airhole 122 of the case 110. The second prong 162 may form the third seal with the first airhole 121. For example, one of the prongs may form one of the seals with one of the airholes when the retainer 150 is inserted into the case 110.

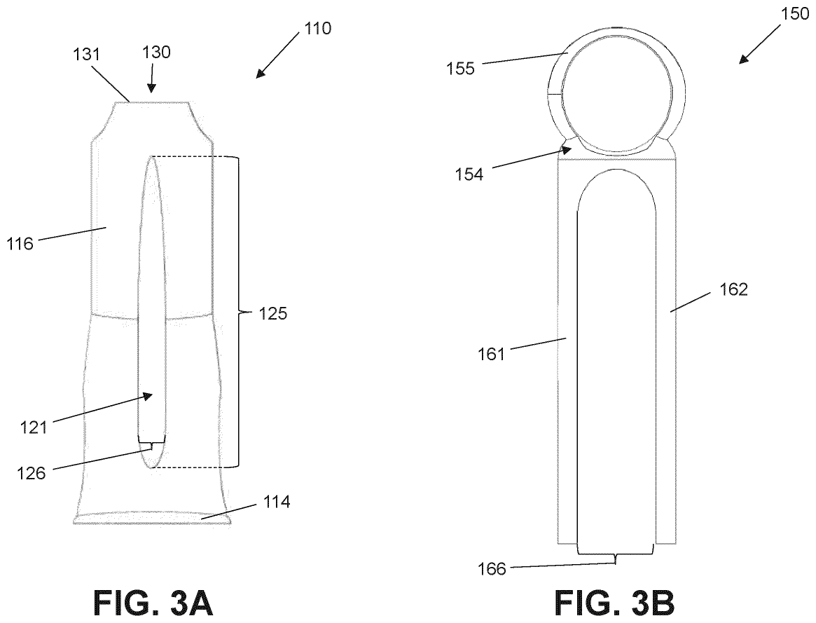

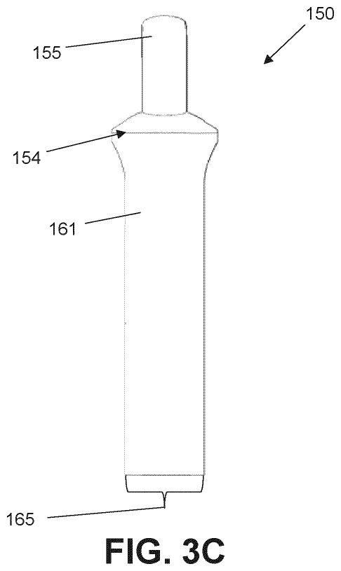

Referring to FIGS. 3A through 3C, a length 125 of the first airhole 121 (and/or the second airhole 122) is less than a height of the case 110. A width 126 of the first airhole 121 (and/or the second airhole 122) is less than or equal to a width 165 of the first prong 161 (and/or the second prong 162). The width 126 of the first airhole 121 (and/or the second airhole 122) may also be less than or equal to a distance 166 between the first prong 161 and the second prong 162, so the prongs may uncover the airholes. For example, it is advantageous for the airholes to be selectively covered by the prongs to keep debris out of the case 110, but it is also advantageous for the airholes to be uncovered so air may flow into the case 110 to unstick the kneadable eraser 190. The prongs having the width 165 greater than the width 126 of the airholes, with the distance 166 between the prongs also greater than the width 126 of the airholes facilitates the selective covering and uncovering of the airholes by the prongs.

In some embodiments, the dimensions (e.g., width, height) of the first airhole 121 may differ from the dimensions of the second airhole 122. In some embodiments, the prongs extend into the case 110 to cover the airholes. For example, a length of the prongs is greater than or equal to a distance between the top of the case 110 (e.g., the first edge 131) and the airholes (e.g., a bottom thereof). For example, the prongs are approximately the same length as the case 110. The length of the prongs is greater than or equal to the length 125 of the airholes.

In some embodiments, the eraser holder 100 is configured for the retainer 150 to rotate within the case 110. In some embodiments, rotating the retainer 150 within the case 110 is configured to form the second seal by positioning the first prong 161 to cover the first airhole 121, when the retainer 150 is rotated into the first position (e.g., a closed position). Rotating the retainer within the case 110 is configured to break the second seal by moving the first prong 161 away from the first airhole 121, when the retainer 150 is rotated into a second position (e.g., an open position). Rotating the retainer 150 within the case 110 may be configured to form the third seal by positioning the second prong 162 to cover the second airhole 122, when the retainer 150 is rotated into the first position. Rotating the retainer 150 within the case 110 may be configured to break the third seal by moving the second prong 162 away from the second airhole 122, when the retainer 150 is rotated into the second position. For example, when the retainer 150 is rotated within the case 110, the prongs may rotate out of the way of the airholes, and the seals on the airholes are broken (e.g., the airholes are uncovered and/or unblocked). For example, when the seals are airtight, breaking the seals allows air to flow into the eraser holder 100. For another example, when the seals are covers for the airholes, breaking the seals (e.g., uncovering the airholes) provides for additional airflow and/or access to the cavity. The retainer 150 may be rotated so the prongs form and/or re-form the seals with the airholes. In some embodiments, when the retainer 150 is inserted into the case 110, the retainer 150 may be inserted into the first position to cover the airholes with the prongs). The retainer 150 may be inserted into the case 110 in the second position, leaving the airholes uncovered.

Referring to FIGS. 1-5B, when the retainer 150 is rotated within the case 110, the first seal between the retainer 150 and the case 110 is broken. The first edge 131 of the case 110 may be positioned atop (e.g., at the open end of) the case 110. The first edge 131 may circumscribe the opening 130. In some embodiments, the first edge 131 is conically shaped. The first edge 131 being conically shaped may ease rotation of the retainer 150 within the case 110. For example, when rotating the retainer 150 within the case 110, the conical shape of the first edge 131 provides for the rotation of the retainer 150 to be partially upwards, making it easier to break the seals between the case 110 and the retainer 150, or respective components thereof.

In some embodiments, the eraser holder 100 further includes the case 110 including and/or defining a cutout 140 (e.g., a track, a groove, etc.). The case 110 may include the cutout 140 formed in the sidewall 116 at the open end of the case 110. For example, the cutout 140 may be defined by the sidewall 116 around the opening 130 on a side portion thereof, such that the cutout 140 defines at least a portion of a perimeter of the opening 130. The cutout 140 may be shaped corresponding to the first prong 161 and/or the second prong 162. For example, the cutout 140 may be generally U-shaped.

In some embodiments, the case 110 may include and/or define a second cutout 141 on an opposite side of the case 110 as the cutout 140 (e.g., a first cutout) and formed in the sidewall 116 at the open end of the case 110. When the retainer 150 is inserted into the case 110, the cutout 140 and/or the second cutout 141 formed in the case 110 may be used to guide the insertion of the retainer 150. For example, the cutout 140 may be configured to guide rotation of the handle 155 relative to the case 110 so that an opening defined by the handle 155 is axially aligned with the cutout 140. Such an arrangement can guide the prongs into alignment with respective ones of the airholes in the case 110 (so that, when the opening of the handle 155 is aligned with the cutouts, the first prong 161 forms the second seal with the first airhole 121 and so that the second prong 162 forms the third seal with the second airhole 122.

In some embodiments, the cutout 140 and/or the second cutout 141 may be positioned to align the prongs with a narrower portion of the case 110, such that the case 110 compresses the retainer 150 (e.g., pushes the prongs toward one another) during insertion of the retainer 150 into the case 110 for retaining the kneadable eraser 190. For example, the sidewall 116 of the case 110 may have a diameter and/or width less than or equal to a diameter and/or width of the retainer 150 in at least one position along the circumference of the case 110. The sidewall 116 may have a larger diameter at an axial position that is aligned with the cutouts so the retainer 150 may begin to be inserted within the cutouts, where a transition from the cutouts to a lower axial position along the sidewall 116 compresses the retainer 150 during insertion into the case 110. By compressing the retainer 150, the sidewall 116 may assist in forming the seals (e.g., the first seal, the second seal, the third seal), where the prongs of the retainer 150 press outward against the inner surface 117 of the case 110. The retainer 150 being sized larger than the case 110 maintains positioning of the retainer 150 within the case 110 by friction between the retainer 150 and the case 110, for example, to maintain the seals and retain the retainer 150 within the case 110, while providing for the retainer 150 to be rotated when enough force is applied by a user (e.g., using the handle 155) to overcome the friction force.

In some embodiments, the sidewall 116 of the case 110 may have the diameter and/or width greater than or equal to a diameter and/or width of the retainer 150. In some embodiments, the case 110 may define additional cutouts. For example, a number of cutouts may correspond to a number of prongs of the retainer 150. The cutouts are configured to not interfere with the rotation of the retainer 150 within the case 110.

In some embodiments, the retainer 150 is shaped where the body portion154 is curved and/or indented, where the shape of the retainer 150 is configured to assist the retainer 150 being inserted into the case 110. For example, the eraser holder 100 may include and/or define one or more recessed portions (e.g., indents, grooves, etc.) in the body portion 154 of the retainer 150, where the recessed portions may support the handle 155. The recessed portions are configured to provide flexibility for the handle 155 to be moved (e.g., to increase the durability of the handle 155 when used by the user to rotate and/or pull the handle 155 to adjust the eraser holder 100). In some embodiments, the eraser holder 100 includes one or more grooves in an external surface of the case 110 (e.g., in an outer surface of the sidewall 116). The one or more grooves may provide additional grip support for the user when holding and/or adjusting the eraser holder 100 (e.g., carrying, rotating the retainer 150, pulling out the retainer 150, etc.).

In some embodiments, the prongs of the retainer 150 may be differently configured. For example, the prongs may be differently configured from each other, where the first prong 161 may have a different shape and/or dimension that the second prong 162. In some embodiments, the retainer 150 includes a post positioned centrally on the retainer 150 (e.g., along a central axis), where the post extends outward from the body portion 154 of the retainer 150. The post extends in an opposite direction to the handle 155 (e.g., downward), where the post is configured for the kneadable eraser 190 to be formed around the post, thereby retaining the kneadable eraser 190 (e.g., because the kneadable eraser 190 is kneadable and/or sticky, the post can stab or spear the kneadable eraser 190 to retain it on the retainer 150). The post has a diameter smaller than the diameter of the kneadable eraser 190. In some embodiments, the retainer 150 may include the post, and the first prong 161 and the second prong 162, where the post is configured to retain the kneadable eraser 190 and the prongs are configured to form the seals with the airholes.

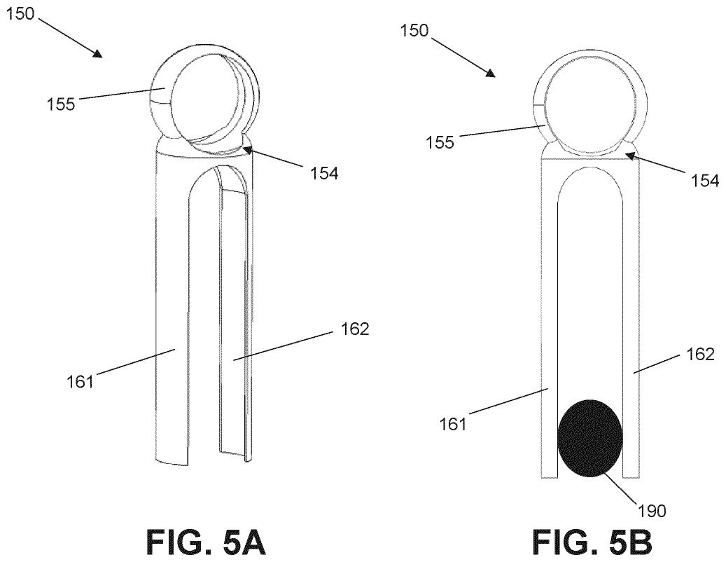

With reference to FIG. 5B, in the depicted embodiment the eraser holder 100 includes a kneadable eraser 190. The kneadable eraser 190 is positioned between the first prong 161 and the second prong 162 of the retainer 150. For example, the retainer 150 holds the kneadable eraser 190, where the first prong 161 and the second prong 162 may be configured as prongs for holding the kneadable eraser 190. In some embodiments, the eraser holder 100 may hold multiple kneadable erasers. The eraser holder 100 may hold 1, 2, 3, or 4 or more kneadable erasers. Additional kneadable erasers may also be positioned between the first prong 161 and the second prong 162.

In some embodiments, the kneadable eraser 190 is positioned between the first prong 161 and the second prong 162 of the retainer 150 via a friction fit. For example, the sticky texture of the kneadable eraser 190 keeps said kneadable eraser 190 positioned between the two prongs using friction. In some embodiments, the kneadable eraser 190 sticks to the inner surface 117 of the case 110. The eraser holder 100 may be configured so the kneadable eraser 190 assists in forming the second seal between the first airhole 121 of the case 110 and the first prong 161 of the retainer 150 via a friction fit to the case 110 (e.g., to the inner surface 117 of the case 110). In some embodiments, the eraser holder 100 is configured so the kneadable eraser 190 assists in forming the third seal between the second prong 162 of the retainer 150 and the second airhole 122 of the case 110 via a friction fit to the case 110 (e.g., to the inner surface 117 of the case 110). For example, because the kneadable eraser 190 is positioned between the two prongs, the kneadable eraser 190 is partially exposed to the case 110 (e.g., the inner surface 117 thereof), when positioned within the case 110, and therefore the sticky texture of the kneadable eraser 190 may cause the kneadable eraser 190 to stick to the inner surface of the case 110, which assists in sealing the eraser holder 100. In some embodiments, the kneadable eraser 190 may assist in forming the first seal.

In some embodiments, where the retainer 150 includes the first prong 161, the case 110 may retain the kneadable eraser 190. For example, the kneadable eraser 190 may be placed into the case 110 for storage. The first prong 161 may be used to agitate and/or move (e.g., drag) the kneadable eraser 190 out of the case 110 when removing and/or rotating the retainer 150 (e.g., the first prong 161 may agitate the kneadable eraser 190 to unstick the kneadable eraser 190 from the case 110 for removal via dumping the kneadable eraser 190 out of the case 110 and/or dragging the kneadable eraser 190 from the case 110 using the retainer 150).

In some embodiments, due to the sticky texture of the kneadable eraser 190, the retainer 150 may become at least partially stuck within the case 110. The retainer 150 being at least partially stuck in the case 110 provides more secure seals for the eraser holder 100 to protect the kneadable eraser 190 within. When the retainer 150 is rotated within the case 110, the prongs rotate out of the way of the airholes, and the seals on the airholes are broken and/or uncovered, allowing air to flow into the eraser holder 100, either unsticking the kneadable eraser 190, or allowing access to the kneadable eraser 190 to manually unstick the kneadable eraser 190 through the airholes on the case 110 (e.g., using a finger, using a pencil, etc.). For example, the retainer 150 being configured with the first prong 161 and the second prong 162 allows the kneadable eraser 190 to be easily accessible and removed from the retainer 150 by removing the retainer 150 from the case 110. And the retainer 150 being configured for insertion into the case 110 not only protects the kneadable eraser 190 from debris, but the retainer 150 being configured to rotate within the case 110 allows for easy removal of the kneadable eraser 190 in the event the kneadable eraser 190 sticks within the eraser holder 100.

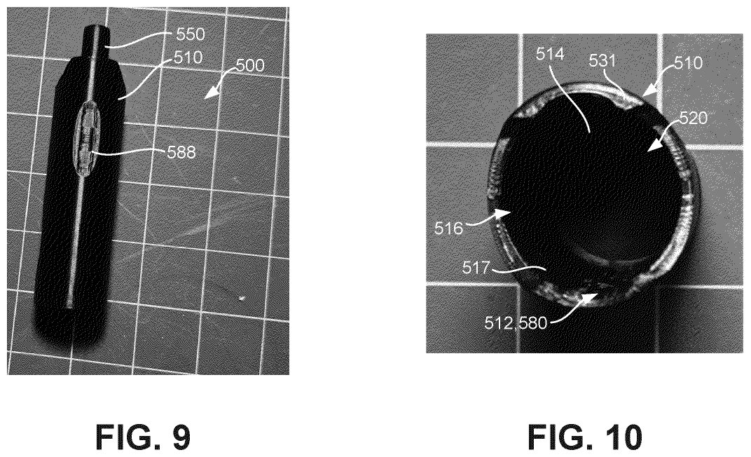

Referring to FIGS. 9-12, another embodiment of an eraser holder 500 is shown, according to an embodiment. For example, the eraser holder 500 and/or components thereof may be similarly configured to the eraser holder 100 and/or components thereof (e.g., the case 110, the retainer 150, etc.). In some embodiments, the eraser holder 500 may include a case 510 and a retainer 550, where the retainer 550 is configured to retain the kneadable eraser 190 and/or be inserted into the case 510 to seal the kneadable eraser 190 therein.

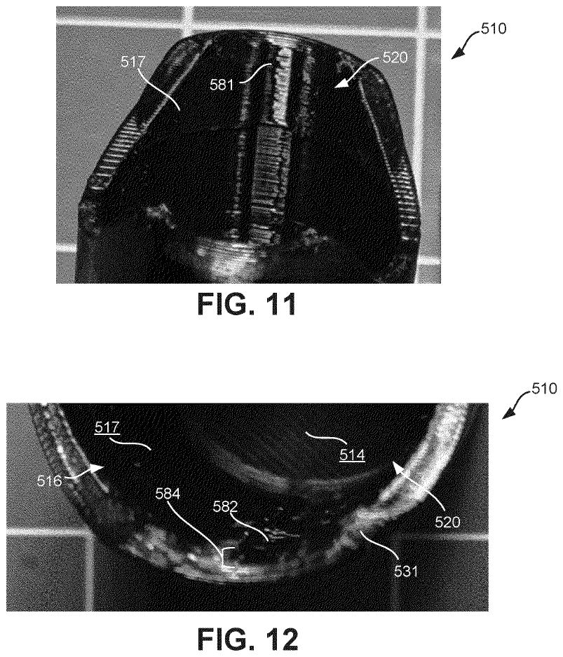

The eraser holder 500 includes the case 510, where one or more airflow features 512 of the case 510 are configured as one or more channels 580 (e.g., passageways, etc.) that are defined by the case 510. For example, the case 510 may include a base 514 and a sidewall 516, where an inner cavity 520 is defined therein. The one or more channels 580 extend at least partially along an inner surface 17 of the sidewall 516. For example, the one or more channels 580 may extend from, or proximate to, a first edge 531 of (e.g., circumscribed around) an opening to the cavity 520 (e.g., a top end of the case 510) to the base 514 (e.g., the bottom end of the case 110), and/or to an intermediate position between the first edge 531 and the base 514. A depth 584 of the one or more channels 580 is sized to provide for airflow through the one or more channels 580 when covered (e.g., sealed, such as by the retainer 550 when inserted into the case 510, etc.). In some embodiments, and as shown in FIGS. 11-12, the sidewall defines a first channel 581 and a second channel 582 on an opposing side of the sidewall as the first channel. In some embodiments, the case 510 may include the first channel 581 instead of, or in addition to, the first airhole 121. The case 510 may include the second channel 582 instead of, or in addition to, the second airhole 122. In some embodiments, the case 510 may include fewer, additional (e.g., a third channel, etc.) and/or a different configuration of channel(s).

In some embodiments, the retainer 550 may be substantially similar to the retainer 150. When the retainer 550 is inserted into the case 510, the first prong 161 may substantially cover (e.g., seal, be positioned over, etc.) the first channel 581. For example, the first prong 161 may form the second seal with the first channel 581. The second prong 162 may substantially cover the second channel 582. For example, the second prong 162 may form the second seal with the second channel 582. The eraser holder 500 is configured such that rotating the retainer 550 within the case 510 selectively forms the second seal by positioning the first prong 161 to cover the first channel 581, or breaks (e.g., uncovers) the second seal by moving the first prong 161 away from the first channel 581. The eraser holder 500 is configured such that rotating the retainer 550 within the case 510 selectively forms the third seal by positioning the second prong 162 to cover the second channel 582, or breaks (e.g., uncovers) the third seal by moving the second prong 162 away from the second channel 582.

Inserting the retainer 550 into the case 510 (e.g., forming the first seal between the first edge 531 of the case 510 and the body portion 154 of the retainer 150) substantially seals the eraser holder 500, such that the kneadable eraser 190 may be substantially protected from dirt, debris, and/or other contaminants. Rotating the retainer 550 relative to the case 510 uncovers the one or more channels 580 (e.g., by rotating the first prong 161 and/or the second prong 162 away from the first channel 581 and/or the second channel 582). Uncovering the one or more channels 580 allows for airflow into the case 510 (e.g., from the open end of the case 510 and through the one or more channels 580), which, for example, may aid in opening the eraser holder 500 and/or unsticking the kneadable eraser 190 from within the case 510 (e.g., due to the sticky texture thereof). Thereby, the kneadable eraser 190 may be sealed within the eraser holder 500 (e.g., to substantially prevent the kneadable eraser 190 from dirt, debris, etc.), where airflow can be selectively provided into the case 510 to assist in removing the kneadable eraser 190 therefrom (e.g., to open the eraser holder 500 by removing the retainer 550, such as via airflow through the one or more channels 580 to unstick the kneadable eraser 190, etc.).

In some embodiments, the case 110 and/or the case 510 may be generally cylindrical. For example, the case 510 may include a substantially uniform width (e.g., a width of the open end is approximately equal to a width of the closed end). Thereby, a profile (e.g., footprint) of the case 510 may be reduced, such that the case 510 may be easily stored (e.g., within a drawer, within a pencil box, etc.). In some embodiments, one or more grips 588 may be defined on the case 510. For example, the one or more grips 588 provide for a user to rotate the retainer 550 relative to the case 510 (e.g., providing for a counter acting force against a direction of rotation of the retainer 550, etc.). In some embodiments, the one or more grips 588 may be a textured portion on the case 510 (e.g., on an outer surface of the sidewall 516, etc.).

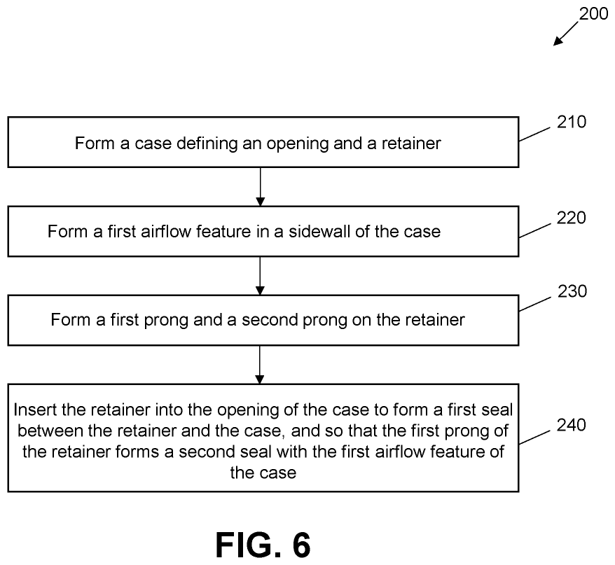

Referring again to FIG. 6, the depicted embodiment shows a method 200 for assembling an eraser holder for a kneadable eraser. The method 200 for assembling an eraser holder for a kneadable eraser includes forming a case defining an opening and a retainer, at method step 210. The method 200 further includes forming one or more airflow features in the case (e.g., in a sidewall thereof), at method step 220. For example, in some embodiments, at least one of the one or more airflow features may be configured as a first airhole. The first airhole may be defined through the sidewall of the case. In some embodiments, at least one of the one or more airflow features may be configured as a first channel. The first channel may be defined in an inner surface of the case (e.g., in the sidewall thereof).

The method 200 further includes forming a first prong and a second prong on the retainer, at method step 230. The method 200 further includes inserting the retainer into the opening of the case, thereby forming a first seal between the retainer and the case, where the first prong of the retainer forms a second seal with a first airflow feature of the one or more airflow features (e.g., the first airhole, the first channel, etc.) of the case, at method step 240.

The method 200 for assembling the eraser holder includes forming the case and the retainer, where the case and/or the retainer may be made from plastic. The case and/or the retainer may be formed by 3D printing. The case and/or the retainer may be formed by molding (e.g., injection molding). Other methods of manufacture may be used to form the case and the retainer.

In some embodiments, the case is formed including an opening. In some embodiments, the case may be formed with a first edge of the case. The first edge of the case may be positioned at the top of the case (e.g., around the opening). The first edge of the case may be formed in a conical shape.

In some embodiments, the method 200 further includes assembling a seal member (e.g., an O-ring) onto the retainer. The seal member may be assembled onto the retainer at a body portion of the retainer. In some embodiments, the seal member may be assembled onto the retainer using an adhesive (e.g., glue). The seal member may form and/or assist in forming the first seal.

In some embodiments, the method 200 further includes forming the first airflow feature (e.g., the first airhole, the first channel, etc.) in the case during the forming of the case. For example, if the case is formed by 3D printing, the first airflow feature may be designed into the case (e.g., the sidewall of the case may be formed with the first airflow feature therein, such as the first airhole defined through the sidewall and/or the first channel defined in the sidewall, etc.). In some embodiments, the first airflow feature may be formed by removing (e.g., cutting out) the first airhole feature from the case (e.g., cutting the first airhole out of the case, forming the first channel in the case, etc.). In some embodiments, the method 200 further includes forming a second airflow feature (e.g., a second airhole, a second channel, etc.) in the case. The second airflow feature may be formed opposite to the first airflow feature. The second airflow feature may have the same dimensions as the first airflow feature.

In some embodiments, the method 200 further includes forming the first prong and the second prong where the prongs are formed opposite each other, where the prongs are configured to hold a kneadable eraser. In some embodiments, the first prong and/or the second prong may be formed at the body portion of the retainer. The first prong and/or the second prong may be formed extending from the body portion of the retainer. The first prong and/or the second prong may extend from the body portion of the retainer in the same direction. In some embodiments, the first prong and/or the second prong may have the same dimensions. In some embodiments, the first prong and/or the second prong may be formed during the forming of the retainer. For example, if the retainer is integrally formed (e.g., 3D printing, injection molding), the first prong and/or the second prong may be formed on the retainer. The retainer may be designed to include the prongs and formed as one piece (e.g., by 3D printing). In some embodiments, other techniques may be used to form the first prong and/or the second prong on the retainer. In some embodiments, the method further includes forming a handle of the retainer. The handle portion may be formed extending from the body portion of the retainer. The handle may be formed extending in an opposite direction from the first prong and/or the second prong. In some embodiments, the handle is formed with the retainer (e.g., 3D printing). The handle may be formed using the same technique as forming the first prong and/or the second prong.

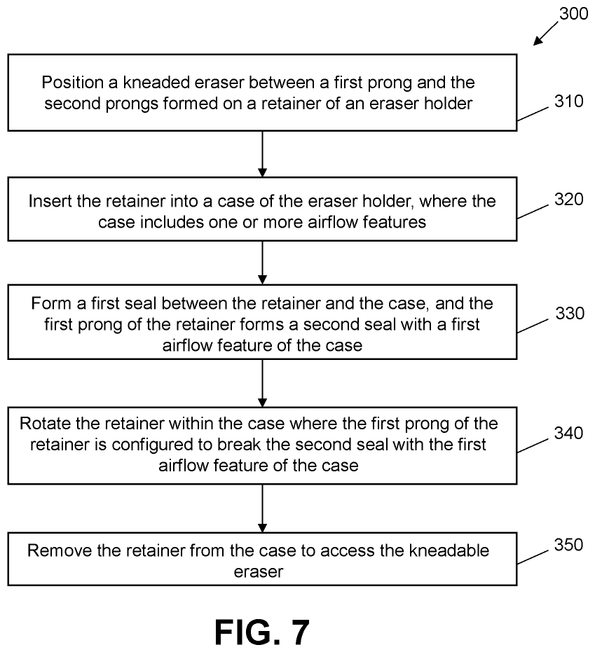

With reference to FIG. 7, a method 300 for containing a kneadable eraser is shown, according to an embodiment. The method 300 includes positioning a kneadable eraser between a first prong and a second prong formed on a retainer of an eraser holder, at method step 310. In some embodiments, multiple kneadable erasers may be positioned between the first prong and the second prong. In some embodiments, the kneadable eraser is held by the first prong and the second prong via a friction fit (e.g., by the sticky texture of the kneadable eraser).

The method 300 further includes inserting the retainer into a case of the eraser holder, where the case includes an opening and one or more airflow features (e.g., airholes, channel, etc.), at method step 320. The method 300 further includes forming a first seal between the retainer and the case, and the first prong of the retainer forms a second seal with a first airflow feature of the case, at method step 330. In some embodiments, the first seal and/or the second seal are airtight. In some embodiments, the first seal and/or the second seal may be defined as a covering (e.g., a blockage). In some embodiments, when the retainer is inserted into the case, the second prong of the retainer forms a third seal with a second airflow feature of the case. The third seal may be similar to the first seal and/or the second seal. In some embodiments, the one or more airflow features may be configured as airholes defined through the sidewall of the case. In some embodiments, the one or more airflow features may be configured as channels defined in an inner surface of the case (e.g., in the sidewall thereof).

In some embodiments, the kneadable eraser may stick to an inner surface of the case via a friction fit. In some embodiments, the kneadable eraser assists in forming the first seal between the retainer and the case via a friction fit (e.g., by sticking to the inner surface of the case). The method 300 further includes rotating the retainer within the case where the first prong of the retainer is configured to break the second seal with the first airflow feature of the case, at method step 340. In some embodiments, when the retainer is rotated within the case, the second prong is configured to break the third seal with the second airflow feature of the retainer. In some embodiments, when the case is formed with the first edge being conically shaped, the retainer is configured to break the first seal between the retainer and the first edge of the case when the retainer is rotated within the case. For example, rotating the retainer within the case is designed to break the seals formed between the retainer and the case. For example, because the kneadable eraser may become stuck inside the case when it is sealed, due to the kneadable eraser's sticky texture, rotating the retainer breaks the seals and allows airflow into the eraser holder through the first and/or second airflow features and/or access to the kneadable eraser. The kneadable eraser may become unstuck and/or the kneadable eraser may be accessed and manually unstuck by a user. The method 300 further includes removing the retainer from the case to access the kneadable eraser, at method step 350.

The method 200 and/or the method 300 may include additional, fewer, and/or a different order of steps. The method 200 and/or the method 300 may be used with embodiments of the eraser holder 100 and/or the eraser holder 500, as described herein.

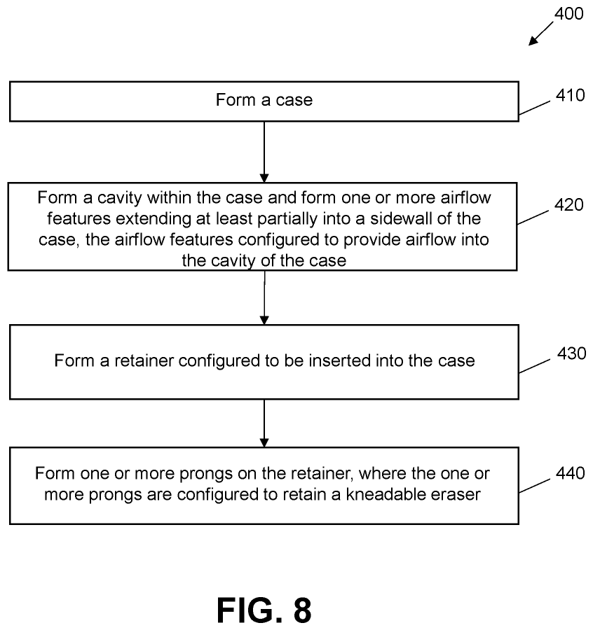

Referring to FIG. 8, a method 400 for manufacturing an eraser holder for a kneadable eraser is shown, according to an embodiment. The method 400 includes forming a case, at method step 410. The method 400 further includes forming a cavity within the case and forming one or more airflow features at least partially in a sidewall of the case, where the one or more airflow features provide airflow into the cavity of the case, at method step 420. In some embodiments, the one or more airflow features may be configured as airholes defined through the sidewall of the case (e.g., providing for airflow through the sidewall and into the cavity). In some embodiments, the one or more airflow features may be configured as channels defined in an inner surface of the sidewall of the case (e.g., providing airflow from an open end of the case, such as from a top end of the case, and into the cavity, such as to a bottom end thereof).

The method 400 further includes forming a retainer configured to be inserted into the case, at method step 430. The method 400 further includes forming one or more prongs on the retainer, where the one or more prongs are configured to retain a kneadable eraser, at method step 440. In some embodiments, forming the one or more prongs on the retainer includes forming the one or more prongs to align with the one or more airflow features of the case. The one or more prongs may mate with the one or more airflow features when the retainer is inserted into the case to form one or more seals (e.g., coverings) between the prongs and the airflow features. In some embodiments, the retainer is formed to rotate within the case when inserted within. Rotating the retainer within the case may break and/or form the one or more seals. In some embodiments, the method 400 may be completed using 3D-printing and/or other known manufacturing techniques.

The method 400 may include additional, fewer, and/or a different order of steps. The method 400 may be performed with various method steps being completed concurrently. The method 400 may be used to manufacture embodiments of the eraser holder 100 and/or the eraser holder 500, as described herein.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (e.g., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. An eraser holder for a kneadable eraser, the eraser holder comprising:
a case comprising:
a base; and
a sidewall, the base and the sidewall together defining an inner cavity, the sidewall defining a first airflow feature; and
a retainer comprising:
a body portion;
a first prong extending from the body portion; and
a second prong extending from the body portion and spaced apart from the first prong, wherein when the retainer is inserted into the inner cavity of the case in a first position:
the body portion is configured to form a first seal with the case, and
the first prong is configured to form a second seal with the case at the first airflow feature.

2. The eraser holder of claim 1, wherein the retainer is configured to rotate within the case.

3. The eraser holder of claim 2, wherein the first prong of the retainer is configured to break the second seal between the first airflow feature of the case and the first prong of the retainer when the retainer is rotated within the case into a second position.

4. The eraser holder of claim 1, wherein the case includes a first edge circumscribed around an opening to the inner cavity, and where the first edge is conically shaped.

5. The eraser holder of claim 1, wherein the first airflow feature is a first airhole defined through the sidewall of the case.

6. The eraser holder of claim 1, wherein the first airflow feature is a first channel defined at least partially in an inner surface of the sidewall of the case, the first channel extending from a first edge circumscribed an opening into the inner cavity of the case to the base thereof.

7. The eraser holder of claim 1, wherein the case further comprises a second airflow feature positioned opposite to the first airflow feature.

8. The eraser holder of claim 7, wherein the second prong of the retainer is configured to form a third seal with the second airflow feature of the case when the retainer is inserted into the case in the first position.

9. The eraser holder of claim 4, wherein the body portion of the retainer forms the first seal with the first edge of the case when the retainer is inserted into the case.

10. The eraser holder of claim 1, wherein the retainer further comprises a handle extending from the body portion for a user to insert a finger through the handle to move the retainer.

11. An eraser holder for a kneadable eraser, the eraser holder comprising:
a case defining a cavity, the case including a sidewall defining:
an opening; and
an airflow feature; and
a retainer configured to be at least partially inserted into the cavity through the opening, the retainer configured to retain a kneadable eraser, the retainer configured to form a first seal with the case at the airflow feature.

12. The eraser holder of claim 11, wherein the retainer comprises a first prong and a second prong spaced apart from the first prong, wherein the first prong and the second prong retain the kneadable eraser.

13. The eraser holder of claim 12, wherein the case defines a first airflow feature configured to provide airflow into the cavity of the case.

14. The eraser holder of claim 13, wherein the case further defines a second airflow feature configured to provide airflow into the cavity of the case, the second airflow feature positioned opposite the first airflow feature.

15. The eraser holder of claim 13, wherein the retainer is configured to rotate within the case when the retainer is inserted into the case, wherein the first prong of the retainer is configured to form a second seal with the first airflow feature of the case, and wherein rotating the retainer within the case is configured to either form the second seal by positioning the first prong to cover the first airflow feature when the retainer is in a first position and break the second seal with the first prong positioned away from the first airflow feature when the retainer is in a second position.

16. The eraser holder of claim 15, wherein the second prong of the retainer is configured to form a third seal with the second airflow feature of the case when the retainer is inserted into the case, and wherein rotating the retainer within the case is configured to form the third seal by positioning the second prong to cover the second airflow feature when the retainer is in the first position and break the third seal by positioning the second prong away from the second airflow feature when the retainer is in the second position.

17. The eraser holder of claim 11, wherein the retainer is configured to rotate within the case when the retainer is inserted into the case, the retainer rotatable using a handle extending from a body portion of the retainer, where the body portion is positioned outside the cavity of the case when the retainer is inserted into the case.

18. A method for forming an eraser holder for a kneadable eraser, the method comprising:
forming a case defining an opening and a retainer;
forming a first airflow feature at least partially in a sidewall of the case;
forming a first prong and a second prong on the retainer; and
inserting the retainer into the opening of the case, thereby forming a first seal between the retainer and the case, and so that the first prong of the retainer forms a second seal with the first airflow feature of the case.

19. The method of claim 18, the method further comprising positioning a kneadable eraser between the first prong and the second prong.

20. The method of claim 19, wherein the retainer is configured to rotate within the case, and wherein the first prong of the retainer is configured to break the second seal between the first airflow feature of the case with the first prong of the retainer when the retainer is rotated within the case.
